(19) United States
(12) Patent Application Publication
(10) Pub. No.: US 2004/0175688 A1
(43) Pub. Date: Sep. 9, 2004

(54) Potty training doll and method of use

(76) Inventor: Melody A. Smith, Lancaster, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/705,189

(22) Filed: Nov. 10, 2003

Related U.S. Application Data
(60) Provisional application No. 60/424,909, filed on Nov. 8, 2002.

(51) Int. Cl. G09B 25/00

(52) U.S. Cl. 434/365

(57) ABSTRACT

A potty training doll has a first aperture formed therein for selectively accessing an internal pouch thereof. A liquid container constructed of resiliently flexible plastic material is disposable within the internal pouch such that a nozzle thereof extends from a second aperture formed in a groin area of the doll. The doll is squeezed to compress the liquid container, causing liquid to be ejected from a nozzle thereof to simulate urination and reinforcing a toilet training experience for a child.

### RELATED APPLICATION

Priority is claimed to Provisional Patent Application Serial No. 60/424,909, filed Nov. 8, 2002.

### BACKGROUND OF THE INVENTION

The present invention generally relates to toilet training devices and methods. More particularly, the present invention relates to a potty training doll which a parent or child care provider can use to toilet train a child in a positive manner.

One of the major challenges faced by most parents and child care providers is the difficulty of training a child in the appropriate use of a toilet. Ideally, such methods and devices should result in rapid toilet training of the child. Lack of proper toilet training is not only an inconvenience, but repeated inappropriate elimination by the child can result in unhealthy and unsanitary conditions, substantial expenses for cleaning and replacing bedding, additional expenses for clothes and diapers, unpleasant odors, as well as a frustrated and strained relationship between the parent and child.

Methods based upon punishment have sometimes been popular in the past. Today, however, it is generally understood that such methods do not work well for toilet training and can traumatize the child and cause prolonged difficulties in toilet training.

There have been designed devices and dolls which simulate urination and can be used for potty training purposes. Some of these dolls, such as that disclosed in U.S. Pat. No. 3,839,819 to Hollingsworth et al., merely disclose a tube extending from a mouth of the doll to a groin area where the liquid is transferred, such as to wet a diaper or the like.

Yet other dolls and devices are fairly complex in nature so as to include many mechanical moving parts, electronics, etc. Examples of such are disclosed in U.S. Pat. No. 3,775,901 to Ellman et al. and U.S. Pat. No. 6,234,862 to Wittenberg.

Other dolls include internal reservoirs which can be filled with fluid or stool-like substances for ejection through valved apertures. U.S. Pat. No. 6,033,229 discloses a medical device in the form of an anatomically correct boy in which a pump is used to eject water through a penis member of the model which is held by hands of the model.

However, these devices all suffer certain drawbacks. Some of these devices are fairly complicated and expensive. All of the devices are specifically directed to urination-simulation devices in dolls and thus serve no other purpose. Moreover, many of these devices in dolls are not soft, cuddly and comfortable to the child and thus lack an emotional attachment with the child.

Accordingly, there exists a continuing long-felt need for a toilet training device and method that can be applied in a positive and loving manner, and is also effective for rapidly teaching a child the proper manner of toilet use. The present invention fulfills this need and provides other related advantages.

### SUMMARY OF THE INVENTION

With the foregoing need and shortcomings of the prior art in mind, it is a primary object of the present invention to provide a toilet training device and method that positively reinforces a toilet training experience for a child.

Another object of the present invention is to provide such a device and method that reduces the time required for toilet training the child.

Still another object of the present invention is to provide an object so that the child being toilet trained can associate the object with a training experience, increased familiarity with the object, and encourage repeated use of the object so as to hasten the child's successful completion of toilet training.

In accordance with the foregoing objects in the present invention, a potty training doll is provided which is easy in use, inexpensive to manufacture and operate, and which the child can relate to as a more normal “cuddly” and soft doll. The potty training doll generally comprises a doll having a compressible portion defining an internal pouch. Typically, the doll is a unisex doll comprised of a stuffed fabric material. A first aperture is formed in the doll for selectively accessing the internal pouch. Fasteners may be used to selectively close the internal pouch aperture.

A compressible liquid container, comprised of a resiliently flexible material, is removably disposable within the internal pouch. The liquid container has a nozzle extending therefrom which extends through a second aperture formed in a groin area of the doll when the liquid container is inserted through the pouch. The nozzle includes a membrane having an aperture therein for the inlet and outlet of liquid. The nozzle also includes a cap which is snap-fit onto the nozzle and pivotally or tethered to the nozzle so as to not be completely removed.

The liquid container is at least partially filled with liquid. This is done by removing the cap and squeezing the compressible liquid container and allowing water to flow into the container as the sidewalls thereof expand outwardly. The cap is inserted over the nozzle and the liquid container positioned within the internal pouch such that the nozzle extends from the aperture of the groin area of the doll. When urination is to be simulated, the cap is removed from the nozzle and the compressible portion of the potty training doll surrounding the internal pouch and liquid container is compressed so as to eject water from the nozzle and liquid container.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a exploded perspective view of a potty training doll embodying the present invention;

FIG. 2 is a enlarged partial-sectional view of area “2” of FIG. 1, illustrating a nozzle of a liquid container used in accordance with the present invention;

FIG. 3 is a diagrammatic perspective view of the liquid container being filled with a liquid;

FIG. 4 is a rear elevational view illustrating the partially filed liquid container being inserted through an aperture and into an internal cavity of the doll;

FIG. 5 is a rear elevational view, illustrating the closure of the aperture and the nozzle of the liquid container extending through an aperture of the groin area of the doll; and

FIG. 6 is a perspective view of a parent or child compressing the doll and causing liquid to be ejected from the nozzle of the liquid container to simulate urination.

### DETAILED DESCRIPTION OF THE PREFERRED EMBODIMENT

As shown in the drawings for purposes of illustration, the present invention is concerned with a toilet training doll kit 10 which can be used by a parent or child care provider in teaching a child the properties of a toilet and to potty train the child.

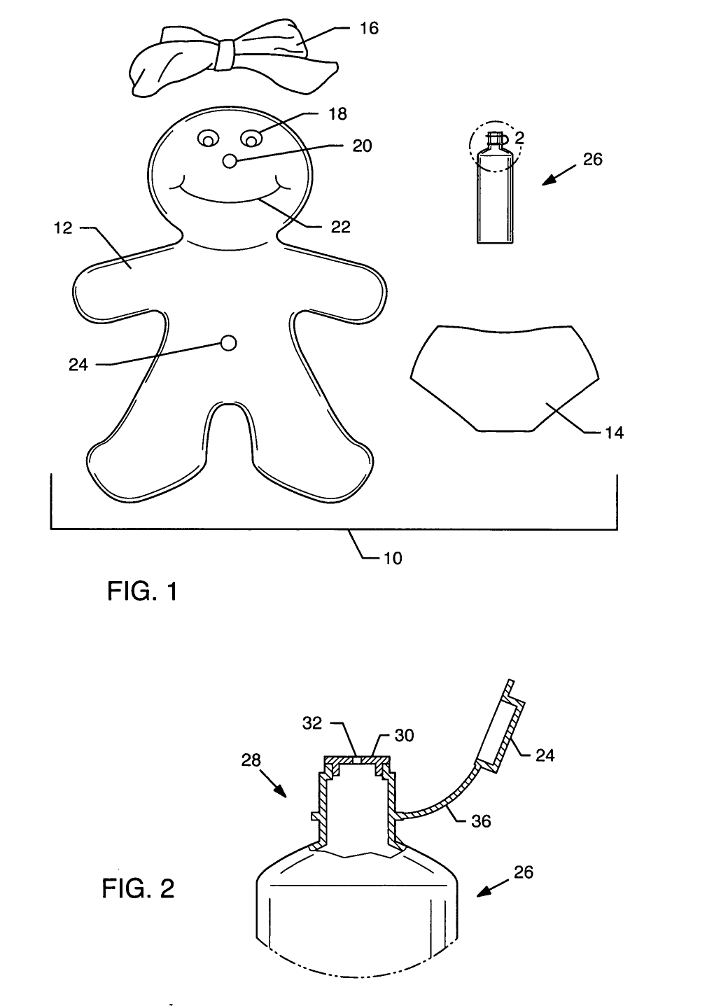

With reference to FIG. 1, the kit 10 includes a doll 12 which is generally comprised of a soft and compressible material, at least around the abdominal portion of the doll 12. In a particularly preferred embodiment, the doll 12 is comprised of fabric stuffed with batting or other such soft and compressible material. As illustrated in the accompanying drawings, the doll 12 is preferably unisex in nature. The doll 12 comes with a pair of shorts or a diaper 14. In order to make the unisex or boy doll 12, a girl, a bow 16 is provided which may be fastened to the head of the doll 12, such as by sewing the bow 16 thereon, gluing the bow 16, or any other fastening means. Alternatively, the doll 12 can be offered as either a boy doll or a girl doll which are sold separately. As mentioned above, the doll 12 is preferably constructed of a soft knit or terry cloth jersey fabric stuffed with non-allergenic or polyester fiber fil or the like. Eyes 18, nose 20, mouth 22 and belly-button 24 are typically embroidered or otherwise fastened onto the doll 12 to give animated, yet human characteristics to the doll 12 so that the child will become enamored and attached to the doll. For safety purposes, these items are securely fastened onto the doll 12, and preferably embroidered for child safety. Although the kit 10 includes a pair of pants or diaper 14, traditional diapers or pull-ups can be used to cover the doll 12 and demonstrate to the child the next step from diapers or pull-ups, namely becoming potty trained.

With reference to FIGS. 1-3, a liquid container 26 is also provided in the kit 10 which, as will be more fully described herein, can be disposed with an internal cavity of the doll 12 to simulate urination. The liquid container is comprised of a resiliently flexible material, such as an appropriate flexible plastic, so as to be compressible. As the doll 12 is typically one foot to one and a half feet in length, the liquid container 26 is usually less than five inches tall so as to fit within the internal compartment of the doll 12. As such, the liquid container 26 contains between three and eight ounces of liquid, such as water. Of course, these dimensions are typical but can be altered to suit the needs of the end user.

The liquid container 26 includes a nozzle 28 extending from an end thereof and having a membrane 30 with an aperture 32 therethrough. The aperture 32 is relatively small, such as a pin-hole size aperture, so that water can be introduced therein and forced out therethrough, yet when inverted water will leak very slowly, if at all, from the nozzle 28. The nozzle also includes a cap 34 which is pivotally connected to or connected by a tether 36 to the nozzle 28 and which snap-fits onto the nozzle 28 to cover the membrane and aperture 30 and 32. It will be appreciated that various caps or lids 34 may be employed, such as push-pull squirt lids and the like. However, due to child safety concerns, the cap or lid 34 should not be capable of being removed from the nozzle 28 and thus serve as a choking hazard.

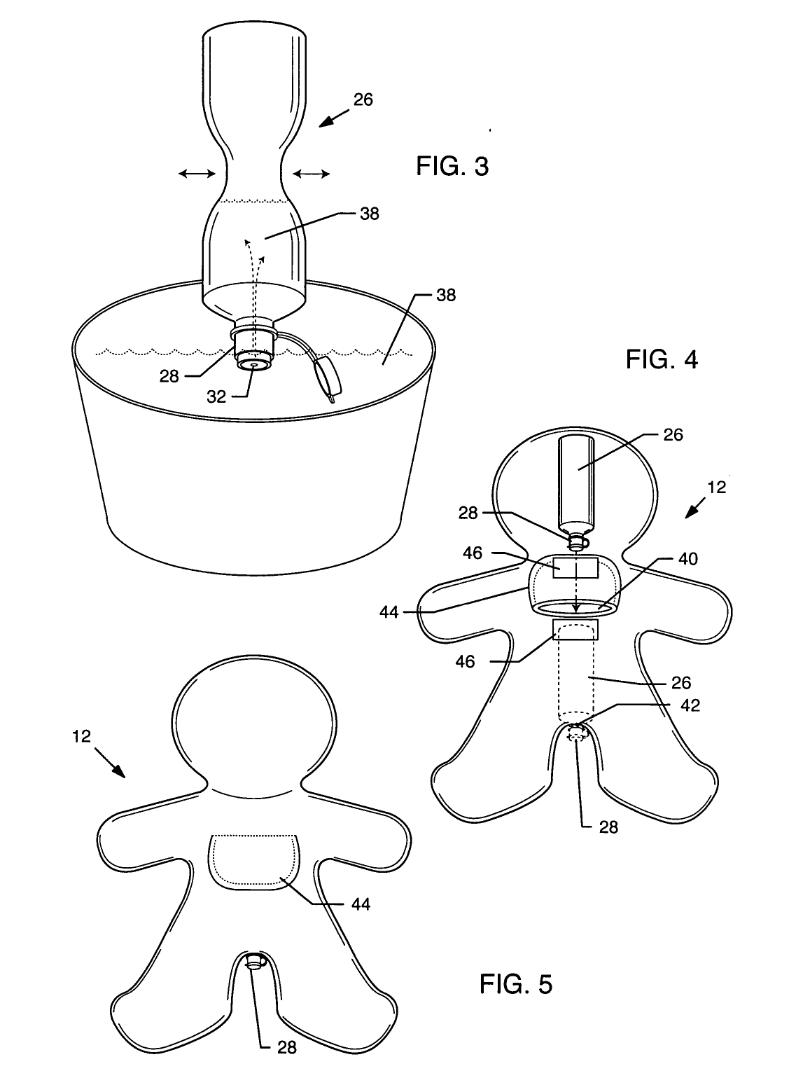

With reference now to FIG. 3, the liquid container 26 is at least partially filled with liquid, such as water. The liquid may comprise water with yellow food coloring to more closely simulate urine. In the particularly preferred embodiment, as illustrated in FIG. 3, the flexible liquid container 26 is compressed and the nozzle 28 submerged in a source of liquid 38 and allowed to decompress such that the liquid 38 enters in through the aperture 32 of the nozzle 28 to at least partially fill the liquid container 26.

With reference now to FIGS. 4 and 5, the cap 34 is then secured over the nozzle 28 and the liquid container 26 inserted nozzle first, into an aperture 40, in the form of a slit, formed in the back of the doll 12. The liquid bottle 26 resides within an internal compartment of the doll 12, as illustrated in FIG. 4. The nozzle 28 extends through an aperture formed in the groin of the doll 12. As illustrated in FIG. 5, the slit 40 is preferably closed by means of fasteners or the like. Such fasteners can include a flap 44 having hook and loop tape 46 which is removably fastened to a portion of hook and loop tape 48 sewn or adhered onto the back of the doll 12 so as to hide the slit and water on the liquid container 26.

It will be appreciated that the removal of the liquid container 26 allows the liquid container 26 to be at least partially filled with water or other liquid without getting the doll wet, or otherwise damaging or soiling the doll 12. Internal reservoirs, which can leak or sprout mold or the like, are also avoided. This arrangement also dramatically reduces the cost of the doll as it is very simple in construction and use.

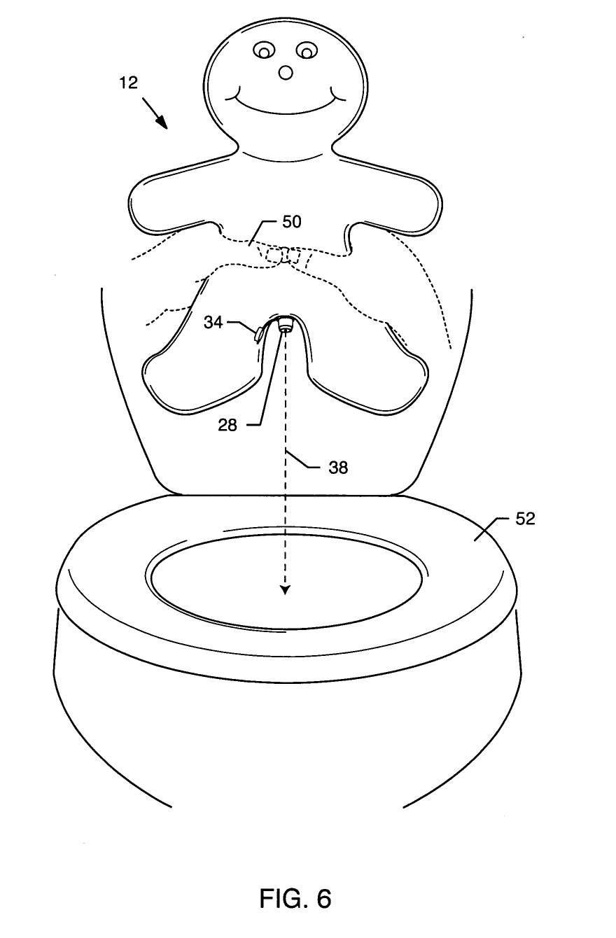

With reference now to FIG. 6, when desiring to simulate urination, the cap 34 is removed from the nozzle 28 and the parent or child places his or her hands 50 about the mid-section of the doll 12 to compress the doll, and thus the liquid container 26 and cause the a stream of liquid 38 to be ejected from the nozzle to simulate urination. This is preferably performed over a toilet 52 to teach the child to urinate in the toilet 52. The belly-button 24 of the doll 12 can be positioned so as to provide a marker or guide for placement of the hands 50 of the user to compress the liquid container 26 and simulate urination.

The doll 12 can help children understand the potty concept and process. A suggested use of the doll 12 in order to facilitate toilet training is to first give the doll a name, for example, Sammy. The care provider shows love and affection towards the doll and asks the child to help take care of it. The parent can also use the appendages and facial features, such as the eyes, nose and mouth of the doll 12 to familiarize the child with the doll and even learn various body parts. If curiosity does not leave the child to remove the diaper or pants 14 from the doll 12, the care provider can remove the pull-up or diaper 14 and inform the child that “this is where the pee-pee comes out”. At an appropriate time for instruction, the care provider states to the child “I think Sammy needs to go potty”. The child is then taken into the bathroom to remove the doll's diaper 14 and hold or sit the doll 12 over the toilet 52. The cap 34 is opened and the doll 12 squeezed about its mid-section so that the water contents the container 26 are pushed out in order to simulate urination, as shown in FIG. 6 and described previously. The child can then flush the toilet for the doll 12 and close the lid. Praise and affection is shown towards the doll, such as by the care provider and child clapping their hands and simulating the clapping of the doll's hands as well. Proper hygiene can also be taught by pretending to wash the doll's hands and explaining to the child the importance of washing hands after using the toilet. The diaper 14 is then placed back on the doll and the doll is given back to the child. The child is then asked if he or she would like to go to the toilet. If the child does, the same praises that were given to the doll is given to the child. If not, the care provider can ask the child to help him or her in the event that the doll 12 needs to go to the toilet at a later time. As the child sees the doll in use and the praises that the doll receives, the child will be more enthusiastic about attempting to use the toilet.

The parent or care provider can wet the doll's diaper 14 when the child is not looking and then ask the child to check to see if the doll's diaper 14 is wet. The child can feel if the diaper is wet and the parent can state “Oh no, Sammy wet his diaper and he needs to go potty”. The parent or care provider can then inform the child that a wet diaper is not a good thing. The process of filling the water container 26 with water and simulating urination over a toilet, accompanied by praises, etc. is repeated. For positive reinforcement, the parent can ask the child to check the doll's diaper 14 when it is dry and subsequently praise the doll 12. Over time, the child imitates the doll 12 by using the toilet and having dry diapers. Thus, the training doll 12 and method of use will help adults and parents of children how to properly use the toilet. The doll 10 of the present invention can be of great assistance not only to parents in the home, but other adults such as grandparents, friends and care providers in day cares, nurseries, etc.

Although several embodiments have been described in detail for purposes of illustration, various modifications may be made without departing from the scope and spirit of the invention. Accordingly, the invention is not to be limited, except as by the appended claims.

What is claimed is:

1. A potty training doll, comprising:
a doll having a compressible portion defining an internal pouch;
a first aperture formed in the doll for selectively accessing the internal pouch;
a compressible liquid container removably disposed within the internal pouch and having a nozzle extending therefrom; and
a second aperture formed in a groin area of the doll and configured to accept the nozzle therethrough;
whereby the liquid container is at least partially filled with liquid, disposed within the internal pouch such that the nozzle thereof extends through the second aperture of the doll, the nozzle opened and the compressible portion of the doll and liquid container are compressed to eject the liquid and simulate urination.

2. The potty training doll of claim 1, including fasteners for selectively closing the internal pouch aperture.

3. The potty training doll of claim 1, wherein the doll is a unisex doll.

4. The potty training doll of claim 1, wherein the liquid container is comprised of a resiliently flexible plastic material.

5. The potty training doll of claim 1, wherein the nozzle includes a membrane having an aperture therein.

6. The potty training doll of claim 1, wherein the nozzle includes a cap pivotally attached thereto.

7. The potty training doll of claim 6, wherein the cap is snap-fit to the nozzle.

8. The potty training doll of claim 1, including a diaper removably attachable to the doll.

9. The potty training doll of claim 1, wherein the doll is comprised of stuffed fabric.

10. A potty training doll, comprising:
a fabric stuffed doll defining an internal pouch;
a first aperture formed in the doll for selectively accessing the internal pouch;
fasteners for selectively closing the first aperture;
a resiliently flexbile liquid container removably disposed within the internal pouch and having a nozzle extending therefrom, wherein the nozzle includes a membrane having an aperture therethrough and a cap for selectively covering the aperture; and
a second aperture formed in a groin area of the doll and configured to accept the nozzle therethrough;
whereby the liquid container is at least partially filled with liquid, disposed within the internal pouch such that the nozzle thereof extends through the second aperture of the doll, the nozzle opened and the compressible portion of the doll and liquid container are compressed to eject the liquid and simulate urination.

11. The potty training doll of claim 10, wherein the doll is a unisex doll.

12. The potty training doll of claim 10, wherein the cap is snap-fit to the nozzle.

13. The potty training doll of claim 10, including a diaper removably attachable to the doll.

14. A method for potty training, comprising the steps of:
providing a doll having an internal pouch accessible through a first aperture thereof and an second aperture formed in a groin portion thereof;
providing a resiliently flexible liquid container having a nozzle extending therefrom;
at least partially filling the liquid container with liquid;
disposing the liquid container within the internal pouch of the doll;
inserting the nozzle of the liquid container through the second aperture of the doll such that it resides external to the doll;
opening the nozzle; and
compressing a portion of the doll about the internal pouch and liquid container causing liquid to be ejected from the nozzle to simulate urination.

15. The method of claim 14, wherein the at least partially filling step comprises the steps of opening the nozzle and filling the liquid container with liquid.

16. The method of claim 15, wherein the filling step comprises compressing the liquid container, inserting the nozzle in a source of liquid, and decompressing the liquid container causing liquid to flow therein through the nozzle.

17. The method of claim 14, wherein the nozzle includes a membrane having an aperture therein and a cap selectively disposed over the aperture.

18. The method of claim 14, including the step of closing the first apertures with fasteners after disposing the liquid container within the doll.
